(19) United States
(12) Patent Application Publication
(10) Pub. No.: US 2008/0129067 A1
(43) Pub. Date: Jun. 5, 2008

(54) Folding utility truck rack with side panels and locking bed cover

(76) Inventor: Antonio Santiago Rios, Vallejo, CA (US)

Correspondence Address: John P. Luther;Newman & Newman, LLP, Suite 610, 505 Fifth Avenue South, Seattle, WA, 98104, US

(21) Appl. No.: 10/894,188

(22) Filed: Jul. 19, 2004

Related U.S. Application Data
(63) Continuation-in-part of application No. 10/161,389, filed on May 31, 2002, now Pat. No. 6,799,784.
Application No. 10/161,389 is a continuation-in-part of application No. 09/567,209, filed on May 9, 2000, now abandoned.

(51) Int. Cl. B60R 9/06

(52) U.S. Cl. 296/3

(57) ABSTRACT

The present invention provides a folding convertible truck apparatus comprising first and second side panels which in turn comprise respective first and second collapsible support members, and in which the side panels comprise inner and outer edges wherein said outer edges are pivotally attached to longitudinal surfaces of lateral truck bed sides by rolled edge means.

### CROSS REFERENCE TO RELATED APPLICATIONS

This application is a continuation-in-part of U.S. patent application Ser. No. 10/161,389, filed on May 31, 2002, which is pending, and which is a continuation-in-part of U.S. patent application Ser. No. 09/567,209, filed on may 9, 2000, which is abandoned.

Copyright Notice 2004 Antonio Santiago Rios. A portion of the disclosure of this patent application/patent document contains material which is subject to copyright protection. The copyright owner has no objection to the facsimile reproduction by anyone of the patent document or the patent disclosure as it appears in the U.S. Patent and Trademark Office patent file records.

### FIELD OF THE INVENTION

The present invention is related to trucks and truck rack systems, and more specifically to a folding or convertible truck rack system comprising side panels which requires minimal labor to unfold and assemble for an expanded operation and use, and to thereafter fold and store in a still useful, but unexpended or collapsed position. The inventive method and system allows a conventionally sized pickup truck or utility truck, or any truck bed for that matter, in general, to substantially increase in size along with its payload or carrying capacity of materials.

### BACKGROUND OF THE INVENTION

Truck bed covers that are capable of converting to a rack means for supporting various materials are not only highly desirable, but are oftentimes indispensable for business and other purposes. In transporting goods such as furniture, refrigerators, lumber and building supplies, landscaping supplies, limber equipment, scaffolding, and machinery, which may be of irregular shapes and/or of extended length, such materials will often not to fit into a pickup or utility truck bed, or only small amounts of such materials and goods may be transported at a time. This situation has created a continuing problem in loss of efficiency and general inconvenience. Spillage and damage, and perhaps pilferage, to materials due to inadequate protection and security during transport compounds the problems. As is known, conventional pickup truck and utility truck beds in general are designed to have relatively short freeboard, or truck bed sides, which may appear stylish to some or capture a traditional look for others, but nevertheless remain inherently inefficient in carrying load capacity, especially with irregular shaped goods and tall goods as exemplified above. Locking truck bed covers applied to such short freeboard provides for small and impractical load carrying spaces making even the transport of a bicycle a problem. There have been various attempts to alleviate these problems such as the suggested installation of inner rack or scaffolding assemblies to truck beds in an effort to increase size capacity. While no doubt increasing carrying size capacity, such arrangements, however, have proved to be a weight hindrance and even hazardous by providing for overloaded and top heavy trucks. The tremendous weight addition of such assemblies has in fact detracted from carrying capacity with the weight of such assemblies taking the place of materials that otherwise could be transported. Other conventional assemblies designed to increase truck bed transporting capacity are not only deficient in structural design, but in protection of goods as well, as lacking any practical security features.

One such conventional example is illustrated in U.S. Pat. No. 3,589,576 which discloses a collapsible rack system in which only a tarp is provided for containment and security of transported goods. This system is also overly complex requiring a multitude of components to be in place for its intended operation, and when disassembled in a non-use mode occupies excessive space which could be used for storing or transporting other goods or materials. Other truck rack systems which are undesirable for similar reasons are disclosed in U.S. Pat. Nos. 4,906,038; 4,509,787; and 4,770,458.

In U.S. Pat. No. 3,765,717 there is disclosed another conventional collapsible truck rack system which can be opened to accommodate side panels. Such panels, however, are not designed or contemplated to be weight or load bearing, and will therefore not support top sided loads as there is not adequate support for the panels to be raised during transport. This reference also describes the presence of supply boxes in the truck bed which will only serve to limit the size and shape of goods which will fit into the truck bed. This apparatus also does not disclose the employ of front and/or rear panel guards which are necessary for containment and security purposes.

U.S. Pat. No. 4,815,786 discloses a convertible system which is deployed by being cranked into place. As illustrated, such device is disadvantageously limited in the range of height achieved, and consequently in convenience and efficiency in the transport of differently shaped objects.

In U.S. Pat. No. 6,513,849 a modular truck rack design is disclosed which is said to be formed from a plurality of standardized preformed parts which can be assembled in various configurations to permit varying extensions, and to “size up” or “size down” the rack to fit any size truck of the same type. A rear bar is provided which is said to permit the truck bed of a pickup truck to carry tall upright items, such as a refrigerator, without the necessity of dismantling the rack. Nothing, however, is provided in the way of security or protection to other truck portions, such as a locked and secured truck bed, or protection to the rear of the cab, and such assembly cannot be easily or quickly dismantled or folded out of the way when not in use; it is a more or less semi-permanent fixture in an upright position in a truck bed once installed providing open access to all passerby.

A similar scaffolding truck bed arrangement is disclosed in U.S. Pat. No. 5,192,107 which shows a rack in the form of a multi-sectioned frame assembly. There are provided front and rear sections with each comprising upper and lower side rails, and with the upper side rails extending forward of the adjacent lower side rails. Vertical uprights connect in an Erector set fashion to form the upper and lower side rails, which are height adjustable. This apparatus is said to be also provided with a telescopic fitting between the front and rear sections to allow for longitudinal and traverse adjustment to differing truck dimensions. As clearly seen, however, again, nothing in the way of security is provided, nor is an easily opened and easily dismantled convertible rack disclosed.

Similar scaffolding-equipped truck bed arrangements are shown, for example, in U.S. Pat. Nos. 2,947,566; 3,765,713; 4,211,448; 5,692,791; 5,628,540; 5,061,000; 5,143,415; U.S. Patent Application Publication No. 2002/0163214 (Nov. 7, 2002) and U.S. Patent Application Publication No. 2004/0026945 (Feb. 12, 2004).

As can be readily appreciated from the above discussion, there therefore exists an important and long felt need for an easily deployable and equally easily collapsible and storable truck bed rack, especially a pick up truck bed rack, endowed with a carrying capacity expandable means and method, and which is safe in use, secure when both deployed and stored, comprised of lightweight durable construction, and further which is generally impervious to the elements including rain when locked in a traditional truck bed cover arrangement, or when deployed in an opened, expanded carrying capacity arrangement. Such means and method are now provided by the superior products and method of the present invention.

### SUMMARY OF THE INVENTION

In accordance with that set forth above, in a preferred embodiment there is provided by the present invention a novel expandable truck bed rack cover means and method comprising first and second side panels longitudinally pivotally attached to the respective right and left longitudinally disposed lateral truck bed sides by respective hinge means, and wherein said first and second panels comprise open and closed positions which can be held in place by front and rear support means, preferably which locked in place, and which may secure bed contents from the rear and also serve to protect the rear truck cab window. In an opened position the aforesaid panels are effective to increase truck carrying capacity, and may also include a lockable cover means which encloses the open tops of both side panels and support members to provide a weather—tight and secure expanded truck bed enclosure. In a closed position the outer lateral, longitudinal edges of each panel with a cover removed are held together by fitting means, and wherein the hinge means and fitting means are effective to create a weather-tight and secure enclosure for the truck bed.

The inventive truck bed rack cover means, method and other aspects and embodiments of the present invention are more fully discussed and are more fully understood by reference to the following Detailed Discussion of Preferred Embodiments and accompanying drawings.

### BRIEF DESCRIPTION OF THE DRAWINGS

FIG. 1 is a top plan view of a folding utility truck rack apparatus with folded side panels according to the present invention in place on a pick-up truck bed.

FIG. 2 is a side view of a folding utility truck rack apparatus similar to FIG. 1 in a non-collapsed operative mode installed on a pick-up truck showing a fully opened right side panel.

FIG. 3 is a side perspective view of the interior portion of a right side panel of a embodiment of a folding utility truck rack apparatus similar to FIGS. 1 and 2 as installed on a pick-up truck bed.

FIG. 4 is a rear perspective view of a folding utility truck rack apparatus similar to FIGS. 1 through 3 as installed on a pick-up truck and illustrating both right and left side panels fully opened from a collapsed and folded position.

FIG. 5 is an additional rear perspective view of the folding utility truck rack apparatus of FIG. 4.

FIG. 6. is a rear perspective view of a folding utility truck rack apparatus similar to FIGS. 1 through 5 showing in operative mode a left side panel moving from a fully opened position to a folded and closed position.

FIG. 7 is a perspective view of the detail of an embodiment of a left side panel of a folding utility truck rack apparatus according to the present invention as installed on a pick-up truck bed and illustrating a collapsible support member attached to the interior of the panel.

FIGS. 7a and 7b are detailed views of features of the support member embodiment of FIG. 7.

FIG. 8 is a perspective view of the detail of an embodiment of a right side panel of a folding utility truck rack apparatus according to the present invention as installed on a pick-up truck bed and illustrating a collapsible support member attached to the interior of the panel.

FIG. 9 is a perspective rear view of the detail of an embodiment of a folding utility truck rack apparatus according to the present invention as installed on a pick-up truck bed and illustrating a front support member in a non-collapsed mode detachably connecting both right and left side panels.

FIGS. 10a and 10b are detailed perspective views of preferred embodiments of side panels of a folding utility truck rack apparatus according to the prevent invention as pivotally attached to the sides of a pick-up truck bed.

FIG. 11 is a detailed perspective exploded view of a preferred side panel pivotal attachment means in accordance with the present invention.

FIG. 12 is a an exploded detailed perspective view of features of the side panel pivotal attachment means of FIG. 11.

FIG. 13 is a perspective view of another preferred embodiment of the folding utility truck rack apparatus in accordance with the invention.

### DETAILED DISCUSSION OF PREFERRED EMBODIMENTS

All patent references, published patent applications and literature references referred to or cited herein are expressly incorporated by reference herein to the same extent as if each were specifically and individually indicated to be incorporated by reference. Any inconsistency between these publications and the present disclosure is intended to and shall be resolved in favor of the present disclosure.

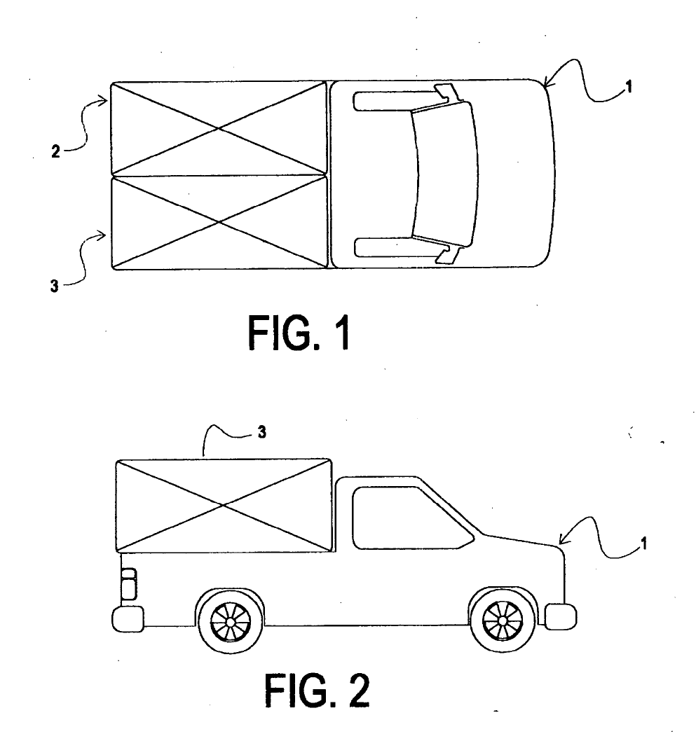

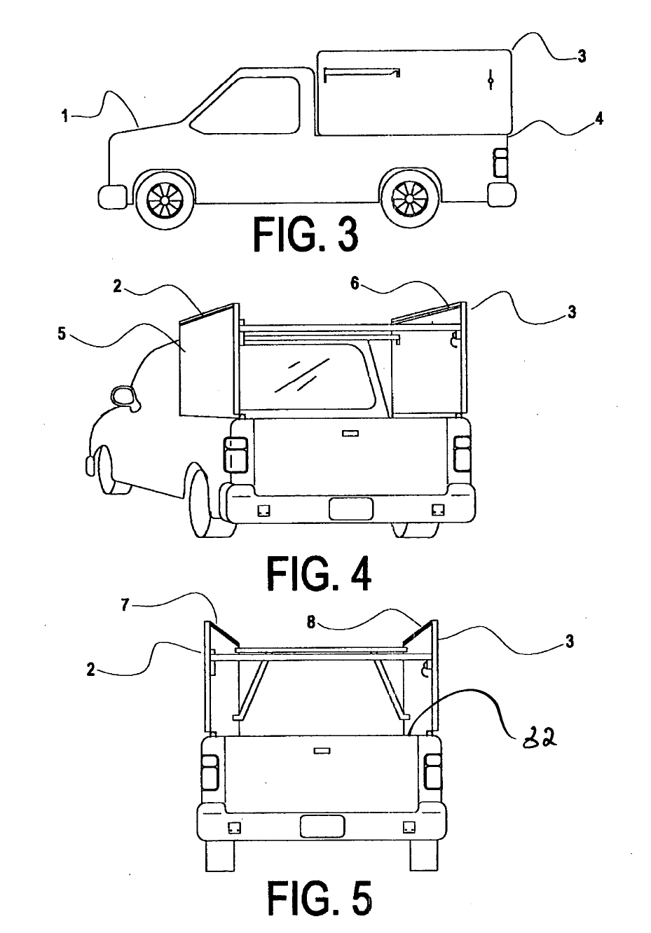

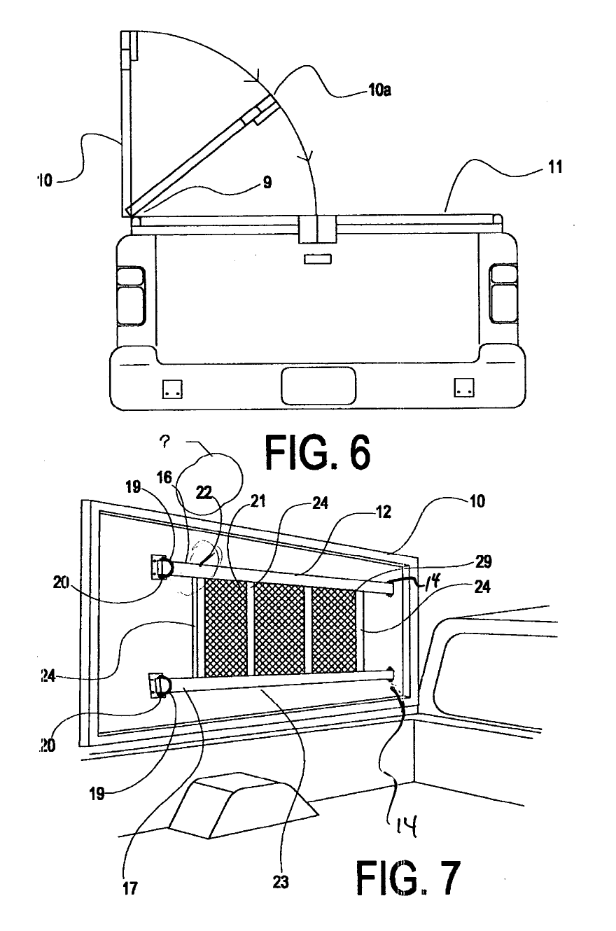

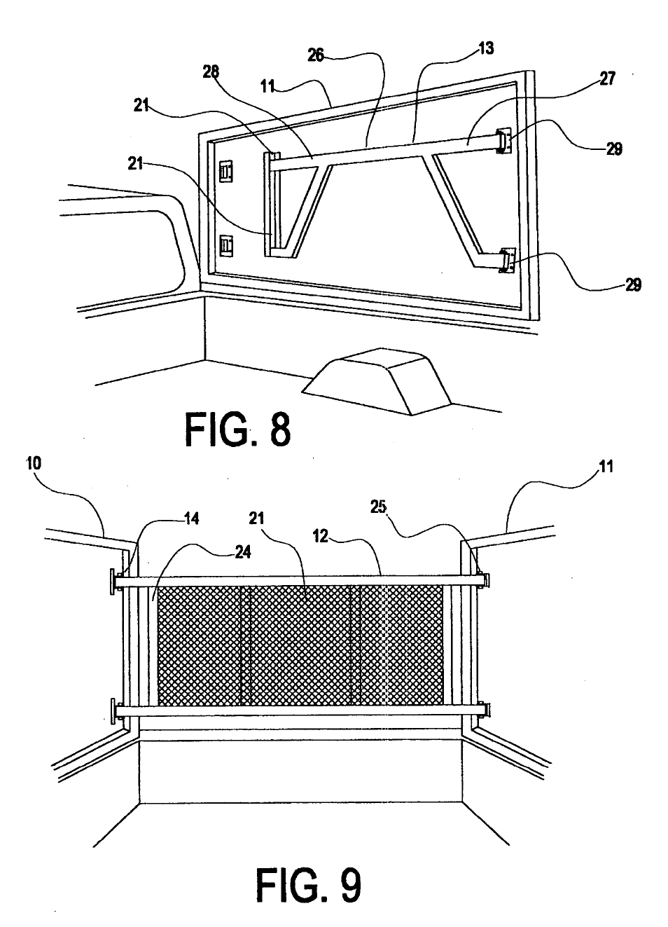

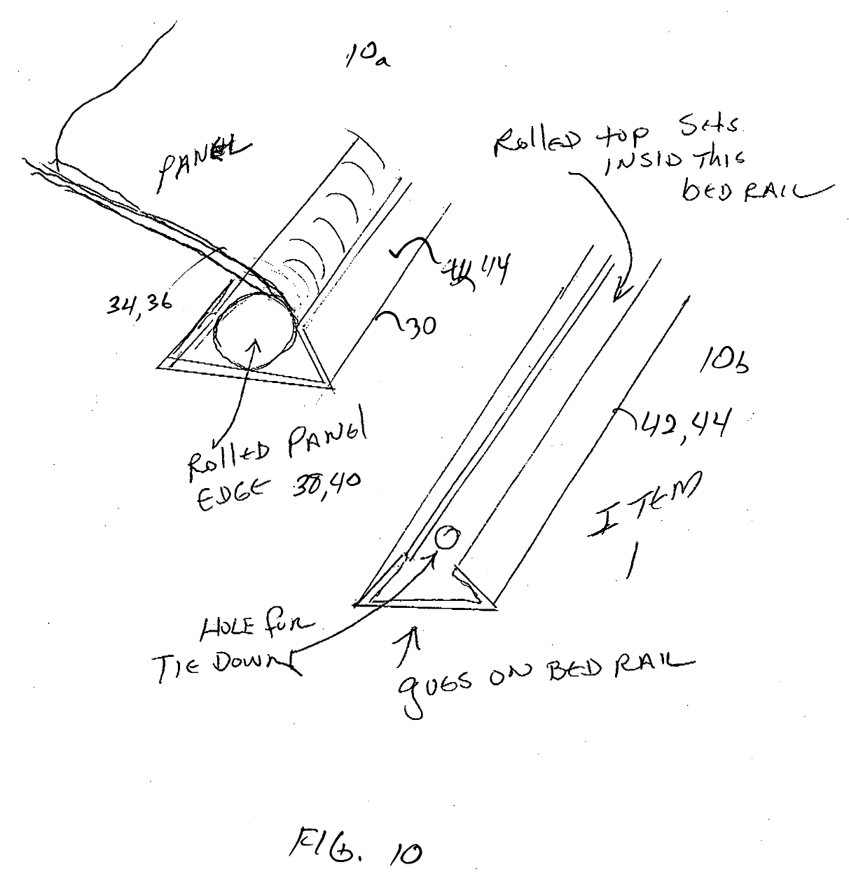

Referring now to FIGS. 1-5, a truck (1) with truck bed (32) is shown having left (2) and right (3), or first and second, panels in a closed and preferably locked bed cover position. Both first and second panels (2 and 3) are pivotally attached longitudinally and laterally to respective truck bed side freeboard top surfaces (34 and 36) by a suitable hinge means (9), and can be lifted, or otherwise opened, to allow the storage or placement of goods and/or materials inside the truck bed (32), and within the expanded enclosed space now provided by the insides of opened panels (2 and 3) which otherwise would not fit if the panels were not opened. As can be seen, in a closed position the left and right panels (2 and 3) provide an enclosed and secure truck bed (32) space such as in conventional manner. Panels (2 and 3) can be rigidly and securely held and locked in place in the open and expanded position to secure goods and/or materials within, preferably by way of front and rear (12 and 13 respectively) collapsible support members, as shown, for example, in FIGS. 8 and 9. Further, the panels (2 and 3) are preferably equipped on their respective open edges opposite their portions pivotally attached to lateral truck bed sides with a latching means, securable in a weather-tight fashion, such as mated interlocking grooves, to provide a weather-tight fitting relationship with each other when the panels (2 and 3) are in a close position, and to provide a secure truck bed enclosure. Pivotal hinge means (9) allows for the left and right panels (2 and 3) to be freely moved from essentially zero degrees in a closed position ninety degrees to a fully opened position relative to the lateral sides of truck bed (32), such as shown in FIG. 6.

The material construction of the panels (2 and 3) is not critical to the practice of this invention, and may be composed of any conventional or non-conventional material(s), such as any metal, composite, or plastic material, or any combination thereof, including, for example, aluminum, fiberglass or fiber-reinforced composites. An effective combination of strength and weight is always desired, and materials of construction may be chosen accordingly to serve any end purpose desired.

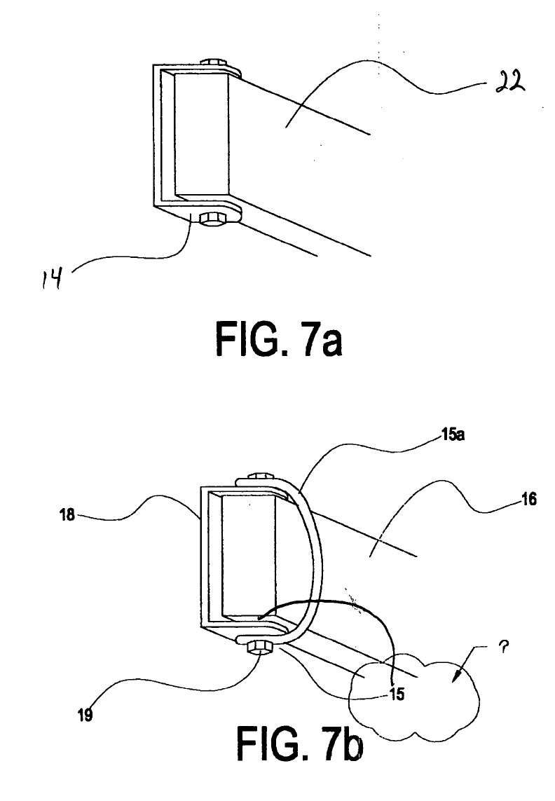

Some preferred features and embodiments with details of the left and right panels (2 and 3), including collapsible support members (12 and 13), are illustrated in FIGS. 6-9. As shown in this preferred embodiment, panels (2 and 3), now referred to as left and right panels (10 and 11 respectively), carry front and rear support members (12 and 13 respectively) which are extendable and collapsible. With respect to the left panel (10) a front collapsible support member (12) is pivotally attached at one end to the framing of panel (10) via a hinge means (14). See, for example, FIG. 7a. The other end of member (12) is detachably connected to the framing of panel (10), which can be any suitable detachable means, such as, for example, by a quick release cotter pin arrangement (15) as exemplified in FIG. 7b, or perhaps by a clasp means such a carabiner or an enclosed hook (not shown). As discussed above, side panels (10 and 11) in one preferred embodiment may have a crimp and groove locking arrangement with one another at their outer respective edges, preferably along the entire longitudinal length of their respective edges. This arrangement preferably is effective to provide a secure and weather-tight fitting relationship when the panels (10 and 11) are in a closed mode, folded and non-upright position, such as illustrated in FIG. 11n such preferred embodiment, for example, right panel (11) may have a crimp or protrusion (not shown) along the longitudinal length of its open edge which fits in a weather-tight seating relationship in a groove 10a along the longitudinal length of the open edge of left panel (10) (also not shown). The employ of any type of gasket material and the like is also contemplated for use herein to ensure any and all effective weather-tight fitting relationships with features of this invention, including the closed and locked side panels as discussed above. Further, any type of locking means is also contemplated for use in this invention to lock and secure the side panels when in a closed and folded position, such as bar lock means extending a full or partial expanse of the longitudinal length of the open edges of the left and right panels (10 and 11).

As shown, for example, in FIGS. 7 and 9, a front collapsible support member (12) may, in a preferred embodiment, be composed of a pair of extending metal pieces (22 and 23), and further optionally provided with one or more perpendicular or transverse support members (24) attaching or otherwise connecting the extending metal pieces (22 and 23) together for added support. As also shown, in yet a further embodiment a suitably desired material in a solid panel, lattice or cross-hatched configuration and the like (29), such as wire mesh or a metal or composite grating and the like, may be provided and/or attached between the metal pieces (22 and 23) to protect the rear cab window of the truck from potentially damaging contact with materials when the panels (10 and 11) are opened, the front support member (12) is opened against the window and detachably connected to the frame of the right panel (11) (such as described below) and the truck bed (32) is loaded with materials of some sort.

In this preferred embodiment, the end railings (16 and 17) of the respective extending metal pieces (22 and 23) of support member (12) fit into their respective seats (18) situated on the frame of the panel (11), as shown in FIG. 7b. Receptive means, such as one or more holes (20) provided in railings (16 and 17) and seat means (18) allow for removable pins (19) to secure the collapsible support member (12) to the interior side of the panel (11) when not in use, although any other suitable securing arrangement is also contemplated for use in this invention.

Further in this preferred embodiment, the rear collapsible support member (13) may comprise an extending frame member (26), as shown in FIG. 8, which may be provided with dual Y-shaped ends (27 and 28) for added support. The right side panel (11) has a rear support member (13) which is pivotally attached at one end (27) to the framing of the panel (11) via a hinge means (20), and is detachably connected at its other end (28) to the framing of panel (11) by a suitable quick release attachment means, such as a quick release cotter pin arrangement (21) as discussed above.

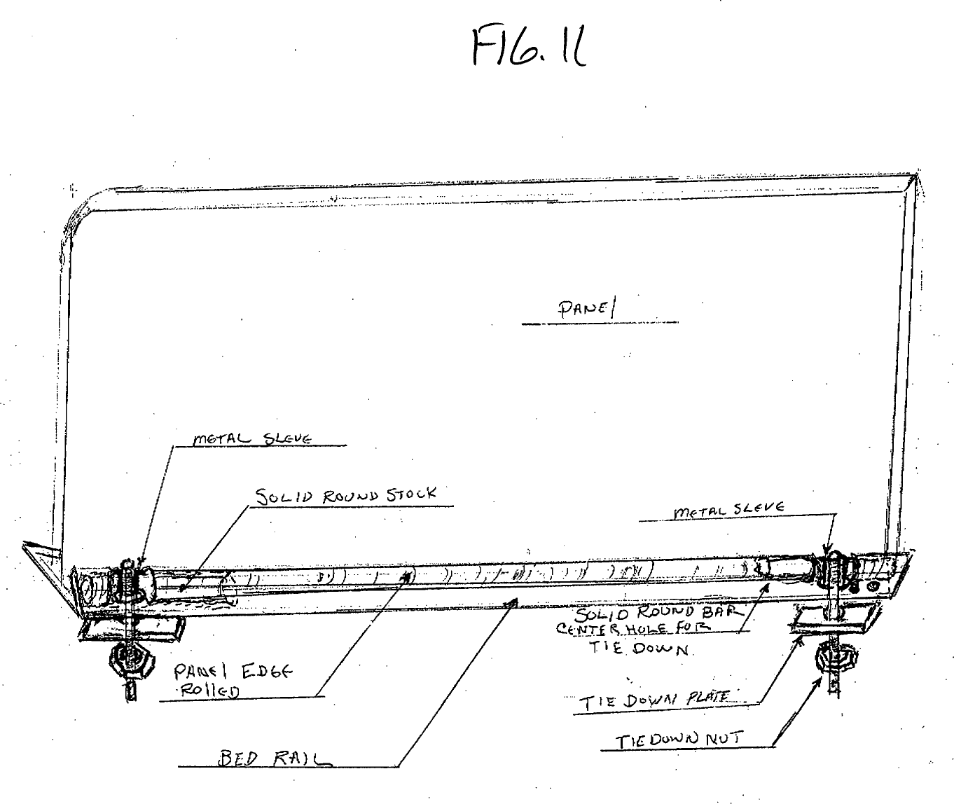

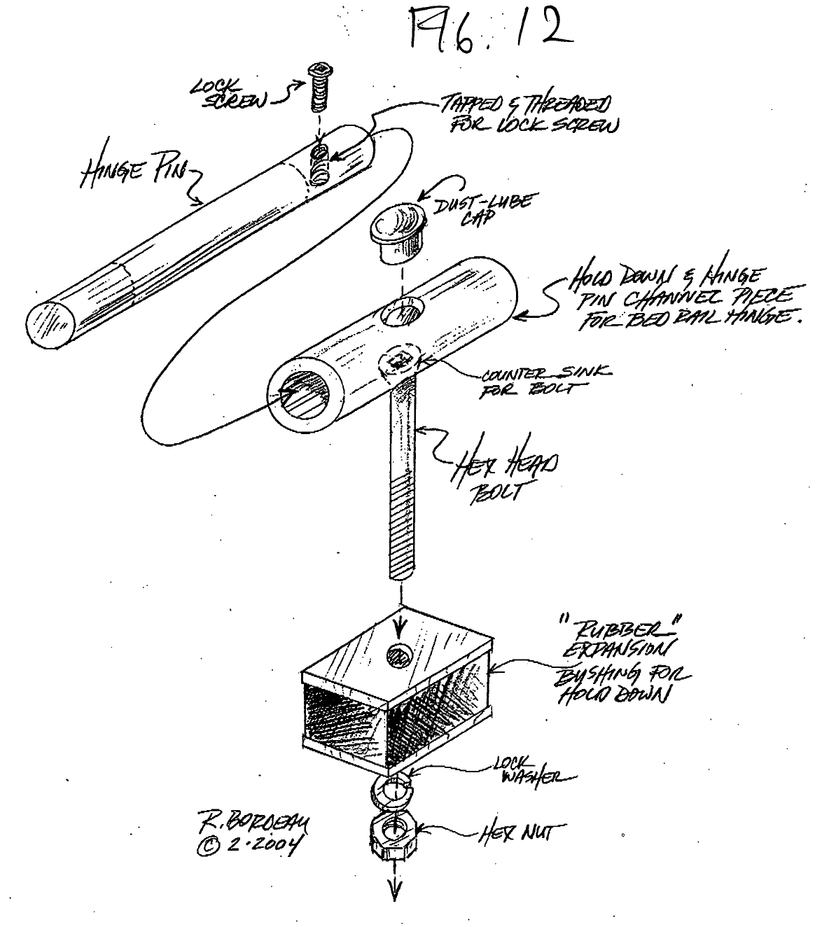

Referring now to FIGS. 10a and 10b, there is illustrated a preferred apparatus and method for pivotally securing via a hinge means (9) the left and right side panels (11 and 12) to the longitudinal side surfaces (30) of the top portions of truck bed (32) lateral side freeboards. As shown in FIG. 10a, each of the respective terminal end edge portions (34 and 36) of the panels (10 and 11) is equipped with a respective rolled panel edge means (38 and 40) of which at least a portion thereof, or the entirety thereof, may be placed and/or fitted within a respective partially enclosed bed rail means (42 and 44) which is situated on each top longitudinal portion of the truck bed (32) side freeboards, and preferably running the length of the truck bed (32). Further, each of the rolled panel edge means (38 and 40) is pivotally movable from essentially zero degrees with respect to the truck bed (32) to essentially ninety degrees with respect to the truck bed (32) as situated within its respective bed rail means (42 and 44), preferably in a snug frictional fitting but yet movable mode, and is preferably fitted in each so as to form a weather-tight nesting relationship at all times, including when one or more panels is in a “closed” relationship or an “open” or “partially open” relationship with respect to the truck bed (32), forming any angle from about 0 degrees to about 90 degrees between the edge portions (34 and 36) and rail means (42 and 44). The bed rail means (42 and 44) may be secured to the longitudinal surfaces of the lateral truck bed sides by any suitable attachment means, such as by screw or nut and bolt means and the like, and may be rubber mounted or a gasket means may be employed therewith both to lessen vibration and to form a weather seal, as desired.

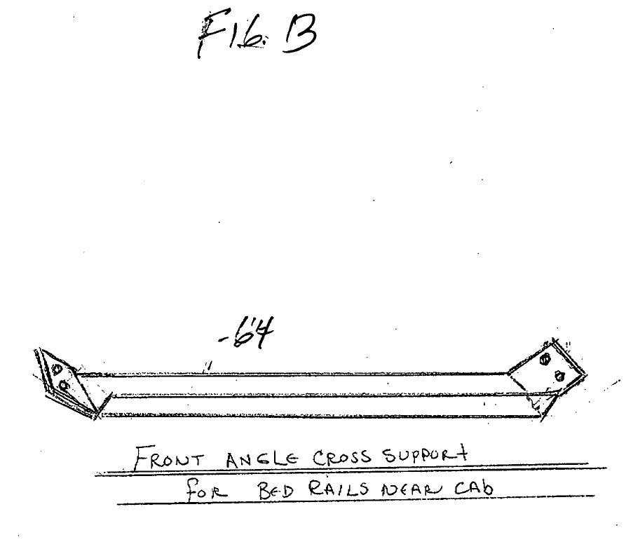

As shown in FIG. 11, there is illustrated an additional preferred embodiment of the present invention for a pivotal attachment means, or hinge means (9), for the left and right side panels to a truck bed's side freeboard top surfaces. In FIG. 11, each of the respective terminal edge portions (34 and 36) of panels (10 and 11) is provided with a rolled panel edge means (38 and 40) which may be in the form of a hollow tube means as nested within respective rail means (42 and 44), or it may be in the form of a partially solid rod, with each rolled edge means (38 and 40) comprising front and back hollow end portions (46 and 48 respectively) for receiving respective hinge pins means (50 and 52) which function to hold the rolled edge means (38 and 40) in place and in a pivotal relationship within rail means (38 and 40) in a male-female hinged relationship of the hinge pin means (50 and 52) and hollow end portions (46 and 48) of the rolled edge means (38 and 40). While any suitable method of attachment of the hinge pin means (50 and 52) to the respective portions of the truck bed's longitudinal side freeboard top surfaces (generally, 30) is contemplated for use herein, a preferred embodiment is disclosed in the perspective detail of FIG. 12. Here, as shown, a hinge pin means (50 and 52) in the form of a hollow or solid pin, which may be composed of any material as desired, such as metal, a synthetic material or a composite, is immovably held, for example, by means of a lock down screw (54), within a hinge pin channel piece (54) and in which the lock down screw (54) is countersunk within the top of a bolt means (56). The bolt means (56) serves to secure the hinge pin means (50 and 52)/hinge channel piece (54) combination to desired portions of the truck bed's longitudinal side freeboard top surface, usually at points at the extreme front and rear portions of a truck bed's sides freeboard (30). The bolt means (56) may be inserted within a truck bed's side freeboard post holes at front and rear positions, or any drilled holes therein, and secured in place with any type of nut means. As further shown in FIG. 12 a rubber enclosed expansion-dampening means (58), which also may function as a tie down plate means, can be employed on the under side of freeboard surface (30) to accept the bolt means (56) after it passes through a freeboard surface portion, optionally after passing through a portion of bed rail means (42 and 44) if it is desired to extend to such a length. The expansion-dampening means (58) is followed by the application of a lock-washer means (60) and is secured by a nut means (62), or some other type of locking nut arrangement means, to tighten and frictionally secure the hinge pin means (50 and 52)/hinge channel piece (54) combination to the top side of the truck bed's side freeboard portion (30), to which combination with hinge pin means (50 and 52) respective rolled panel edge means (38 and 40) may be secured in a hinged relationship within the respective bed rail means (42 and 44) on both side of the truck bed, such as discussed above.

As further shown in FIG. 13, in yet another preferred embodiment of the present invention, a transverse rail (64) may be provided with each of its ends adapted to fit and be secured to bed rail means (42 and 44) on both sides of a truck bed (32) at the ends nearest the truck cab in a fitting relationship effective to form a weather-tight seal with the left and right panels (11 and 12) when in a closed and folded position to secure the contents of the truck bed as desired.

In operation, the side panels (10 and 11) are opened ninety degrees by pivoting on their respective hinge means (9) in a vertical motion to form right angels in relation to the truck bed (32). The front support member (12), as situated on the left side panel (10) in the example embodiments, is extended by releasing the attachment means as exemplified by the cotter pin arrangement (15), and by moving the support member (12) ninety degrees on its hinge and aligning holes (20) with a set of seat means (25) attached to the framing of the opposite side panel (11), and locking the hole means (20) into place with seat means (25) on the framing such as with a cotter pin arrangement. The rear support member (13) exemplified as situated on the right side panel (11) is then extended by releasing similar attachment means, such as a cotter pin arrangement (15), moving the support member (13) on its hinge means (14) ninety degrees and locking the member (13) into place on a provided seat means on the framing of the left side panel (10), again such as by a cotter pin arrangement. Once extended, the front and rear support members (12 and 13) in combination with the left and right panels (10 and 11) provide for a conveniently well expanded, secure and stable loading area and platform for the truck bed which would be greatly reduced in size without the features of the inventive folding truck rack. As also shown above, the front support member (12) may be optionally modified to protect the rear glass of the truck cab from accidental breakage by loaded materials in the truck bed (32).

Additionally, when both left and right side panels (10 and 11) are fully opened in an unfolded upright position relative to the truck bed with front and rear collapsible support members (12 and 13) in place, along with the transverse rail (64), the entire open top portion formed by the left and right panels (10 and 11) and support members (12 and 13) may be provide with a cover means (not shown), which may be weather-tight for added protection of loaded and transported materials, and also to provide an expanded cargo space secure from theft.

It will be further appreciated by those persons skilled in the art that the embodiments described herein are merely exemplary of the principals of the invention. While some preferred embodiments have been described, modification in any way may become apparent to those of ordinary skill in the art following the teaching of the invention, without departing from the spirit and scope of the invention as set forth in the appended claims. Additionally, any and all embodiments described herein are merely for illustrative purposes only and are specifically not intended to limit the scope of the invention and/or claims in any way.

What is claimed is:

1. A collapsible truck bed rack apparatus which converts to a rack for transporting goods and/or materials comprising first and second side panels wherein said first and second side panels each comprise inner and outer edges with said outer edges pivotally attached by way of a rolled edge means to a longitudinal surface of a lateral side freeboard area of a truck bed, and wherein said first and second side panels have opened and closed positions whereby in said closed position said inner edges of the first and second side panels fit together.

2. The truck rack apparatus of claim 1 wherein said first and second side panels fit together in a secure weather-tight closure.

3. The truck rack apparatus of claim 1 wherein said first and second side panels comprise respective first and second collapsible support members attached to said respective panels by a hinge means at one end and a detachable means at the other end, whereby when said panels are in an open position each of said first and second collapsible support members is effective to pivot on its hinge means after being disconnected from said respective panel at its other end from said detachable means and then be detachably connected to the other respective panel to form an expanded rigid enclosed cargo space with said side panels on the truck bed.

4. The truck rack apparatus of claim 3 wherein one of said first and second collapsible support members is situated at the rear end of the truck bed and the other member is situated at the front end of the truck bed juxtaposed to the truck cab window.

5. The truck rack apparatus of claim 4 wherein said rear collapsible support member comprises two substantially parallel members with ends forming dual Y-shaped ends, with one end connected to one side panel by a hinge means and the other end connected to the side panel by a quick release detachable means.

6. The apparatus of claim 5 wherein said quick release means is a cotter pin arrangement.

7. The truck rack apparatus of claim 4 wherein said front collapsible support member juxtaposed to the truck cab window comprises an upper framing member connected to a lower framing member with a plurality of transverse members connecting said upper and lower members, and further comprising one selected from a solid panel, a lattice panel and a screen means deposed between the upper and lower framing members.
